(19) United States
(12) Patent Application Publication
(10) Pub. No.: US 2005/0013065 A1
(43) Pub. Date: Jan. 20, 2005

(54) Integral transformer junction module

(76) Inventor: George W. Kersten, East Troy, WI (US)

Correspondence Address: FOLEY AND LARDNER;SUITE 500, 3000 K STREET NW, WASHINGTON, DC, 20007, US

(21) Appl. No.: 10/866,082

(22) Filed: Jun. 14, 2004

Related U.S. Application Data
(60) Provisional application No. 60/477,763, filed on Jun. 12, 2003.

(51) Int. Cl. H02H 7/04

(52) U.S. Cl. 361/38

(57) ABSTRACT

A compact integral transformer-junction module combination suitable for use in junction modules and vaults in electrical distribution circuits and in industrial and commercial circuits, comprising: a transformer, and a sectionalizing element comprising a plurality of primary bushings, wherein the sectionalizing element is combined with the transformer into a single unit, and the plurality of primary bushings are connected together, via an internal connection within the unit.

### CROSS-REFERENCE TO RELATED PATENT APPLICATIONS

This application claims the benefit of U.S. Provisional Application 60/477,763, filed Jun. 12, 2003, the entire contents of which, including the specification and drawings, is incorporated herein by reference.

### FIELD OF THE INVENTION

The present invention relates to an electrical distribution system and a voltage transformer.

### BACKGROUND OF THE INVENTION

Supplying secondary power at a junction of an underground electrical distribution system typically requires that a separate transformer be connected to a junction module. Peripheral cables within the underground distribution system may be connected between the transformers, switchgear, vaults, junction boxes, and other hardware. In one method of sectionalizing an electrical distribution system and supplying power to a local site simultaneously, cables are connected to a junction module located within a sectionalizing cabinet. The cables are then redirected from the junction module to the stand-alone transformer, which is typically located within close proximity to the sectionalizing cabinet. As an alternative, a pole mount transformer might be placed inside the sectionalizing cabinet. Whether the transformer is inside or close to the cabinet, the junction module is still connected to the transformer by external cables, cable terminations (“elbows”), and other associated connection hardware. Therefore, there is a need for a system that joins both units without the external connections.

### SUMMARY OF THE INVENTION

According to one aspect of the invention, there is provided a method for combining a sectionalizing function and a transformer function for an electrical distribution system. The method includes providing a transformer, having multiple primary bushings, preferably recessed, that have a sectionalizing function, and joining the bushings and the transformer into a single unit, preferably in a single housing that provides for an internal connection of the transformer and the junction module, for example, by a connection from a bus. The current embodiment sectionalizes the primary circuit, provides secondary power to external applications, and joins the bushings and the transformer into a single unit without using an external primary connection of the junction module to transformer. Secondary power may be provided to applications external to the system, for example, street lights, billboards, controls, etc. This embodiment eliminates the use of a stand-alone transformer, transformer pad, external cables, elbows, junction module, ground rod, and associated connection hardware. An additional advantage of the single-unit transformer junction module is that it can avoid use of unnecessary core watts or excessive winding watts by employing a properly sized unit, instead of the typical de-rated 10 kVA padmount units, in applications requiring less than 10 kVA.

According to another aspect of the invention, there is provided a system for combining a sectionalizing function and a transformer function for an electrical distribution system. The system includes a transformer, multiple bushings, preferably recessed, having a sectionalizing function, and typically a fuse holder that protects a core/coil assembly. Multiple bushings are bussed together and are combined with the transformer into a single unit, preferably in a single housing that provides for an internal connection of the transformer and the junction module, for example, by a connection from a bus. The current embodiment joins the bushings and the transformer into a single unit and provides secondary power to applications external to the system, for example, street lights, billboards, controls, houses, etc., without using one of the primary connectors to provide the connection between the transformer and junction module. The embodiment also provides energy efficiency substantially higher than methods employed in typical pad mounted applications less than 10 kVA. The bushings are preferably recessed from the front elevation of the unit and are preferably vertical or upwardly angled to aid in the installation and removal of elbow connectors during typical pad mount applications.

In one embodiment, the tube secures a fuse stabber, which contains a fuse that protects a core/coil assembly of the transformer. The tube may be mounted in the deck at an angle, preferably multi-dimensional angles, sufficient to permit removal of the fuse stabber when the transformer junction module is installed in a cabinet or vault, such that upon removal it clears the cabinet overhang and minimizes dielectric fluid spill or contamination of the molded rubber products. The transformer may be protected within the assembly by a fuse, a fault interrupter, or other appropriate method. The system may also include a fuse holder tube (the “tube”), which may be inserted into the surface of the transformer junction module deck for securing a transformer protection assembly. There may also be cases where no over-current protection is required, thus eliminating the need for a protection assembly of any kind.

In another embodiment, there is provided a system for combining a sectionalizing function and a transformer function for an electrical distribution system. The system includes a transformer, multiple primary bushings, preferably recessed, having a sectionalizing function, and typically a fuse holder that protects a core/coil assembly. The secondary power provided through secondary bushings, secondary blocks or other method in a secondary compartment that is accessed through a separate door, different angle or other method from that used for accessing the primary bushings. The compartment is distinct and separate from the primary bushing area, preferably separated or defined by dielectric material to increase safety for personnel. The dielectric boards supporting the secondary bushings or blocks can be mounted on hinges, slides, or other method to allow for movement which will facilitate a visible break from the energized transformer, to visibly indicate separation of secondary connections. Alternatively, the secondary connectors themselves can be movable in order to provide such a visible break.

In another embodiment, there is provided a system for combining a sectionalizing function and a transformer function for an electrical distribution system. The system includes a transformer, multiple primary bushings, preferably recessed, having a sectionalizing function, and typically a fuse holder that protects a core/coil assembly. Internal to the primary bushing/transformer housing itself is a core/coil assembly, the internal section of the fuse tube and a gas deflecting assembly, which diverts and diffuses gasses, generated within the housing from arching under dielectric fluid (e.g., from switching or an over-current event). This housing deflects conductive gasses away from the ground plane and directs these gases up and over to the area of the safety relief valve.

In another embodiment, the external wall of the gas deflecting assembly, opposite the side on which gasses may be generated, is used to support internal protective devices; in the preferred embodiment this means a back up partial range current limiting fuse. This housing can thus advantageously serve as a mechanical support mechanism for current limiting, other fusing or over-current devices and/or internal over-voltage protection device, such as a MOV arrester or other method of protecting for over-voltage or over-current.

According to a further aspect of the present invention, there has been provided a transformer unit, comprising: a transformer core with windings; at least one primary high voltage connection point on the transformer; and at least one secondary lower voltage connection point on the transformer, wherein the secondary lower voltage connection point comprises at least one secondary block mounted on a support mechanism, and the support mechanism is selectively movable to open the electrical connection between the secondary connection point and the transformer and to provide a visible indication of the opened electrical connection.

Further objects, features and advantages of the present invention will become apparent from the detailed description of preferred embodiments that follows, when considered together with the accompanying figures of drawing.

### BRIEF DESCRIPTION OF THE DRAWINGS

The invention will be more readily understood by reference to the following description taken with the accompanying drawings, in which:

FIG. 1 shows a prior art system with a sectionalizing cabinet and an external transformer showing external connections to a junction module.

FIG. 2 shows a transformer junction module installed in a sectionalizing cabinet in accordance with one embodiment of the present invention.

FIG. 3 shows an isometric view of a transformer junction module with top-mounted horizontal bushings in accordance with one embodiment of the invention.

FIG. 4 shows an isometric view of a transformer junction module with removable top-mounted horizontal bushings in accordance with one embodiment of the invention.

FIG. 5 shows a core/coil assembly of the transformer junction module of FIG. 2 and a fuse holder tube projecting from the deck of the transformer junction module of FIG. 2.

FIG. 6 is a perspective view showing a transformer junction module in accordance with a second principal embodiment of the present invention.

FIG. 7 is a detailed perspective view showing the secondary connectors in the device of FIG. 6.

FIG. 8 is a perspective view illustrating a gas deflector unit that may be included in the devices according to the invention.

### DESCRIPTION OF PREFERRED EMBODIMENTS

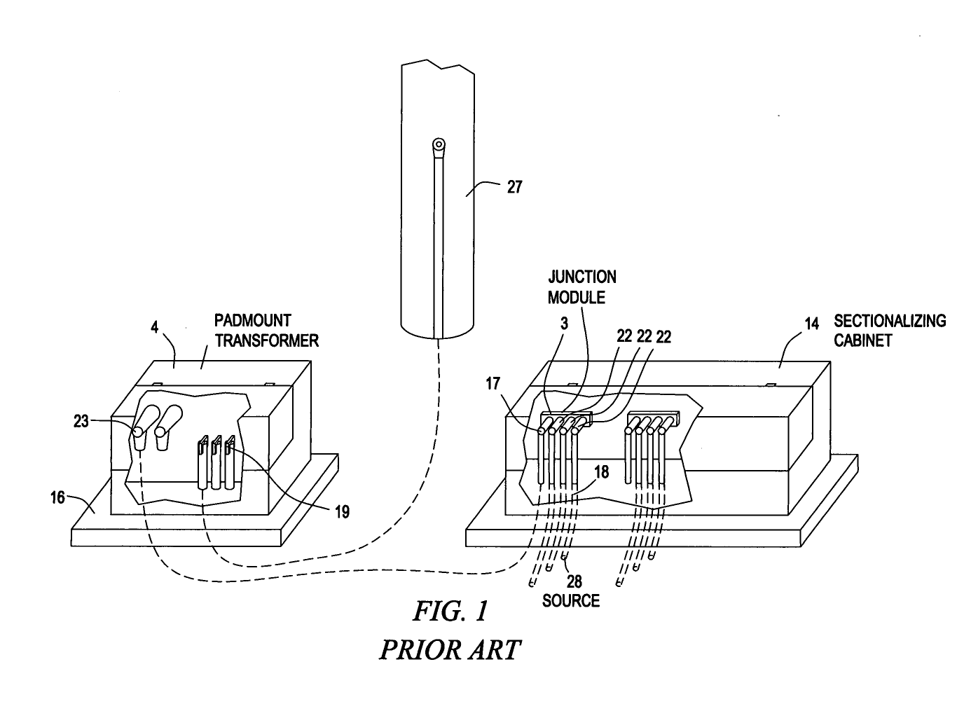

Referring now to the drawings, FIG. 1 shows a prior art system for connecting a stand-alone transformer 4 with a sectionalizing cabinet 14 containing a junction module 3. The stand-alone transformer 4 may be, for example, a pad mount transformer. Junction module 3 is connected to transformer 4 by elbow connectors 17 and cables 18 from one of the junction module positions 22 to one of the primary bushings 23 of transformer 4. Junction module 3 may consist of four junction module positions 22, which typically connect to transformer 4 and an external power source 28, leaving typically two positions available to route power or one position for connecting a lightning arrester and one position to route power. Typically, three transformer junction modules 3 are installed in a sectionalizing cabinet 14 to accommodate three-phase power, but configurations may vary based on system requirements.

Stand-alone transformer 4 is typically mounted on a transformer pad 16. Transformer 4 typically consists of two primary bushings 23, in which one of the connections is to one of the junction module positions 22. Transformer 4 also typically consists of three low voltage secondary terminals 19. The secondary terminals 19 are typically used to supply power to applications 27 external to the system, such as streetlights, billboards, controls, etc.

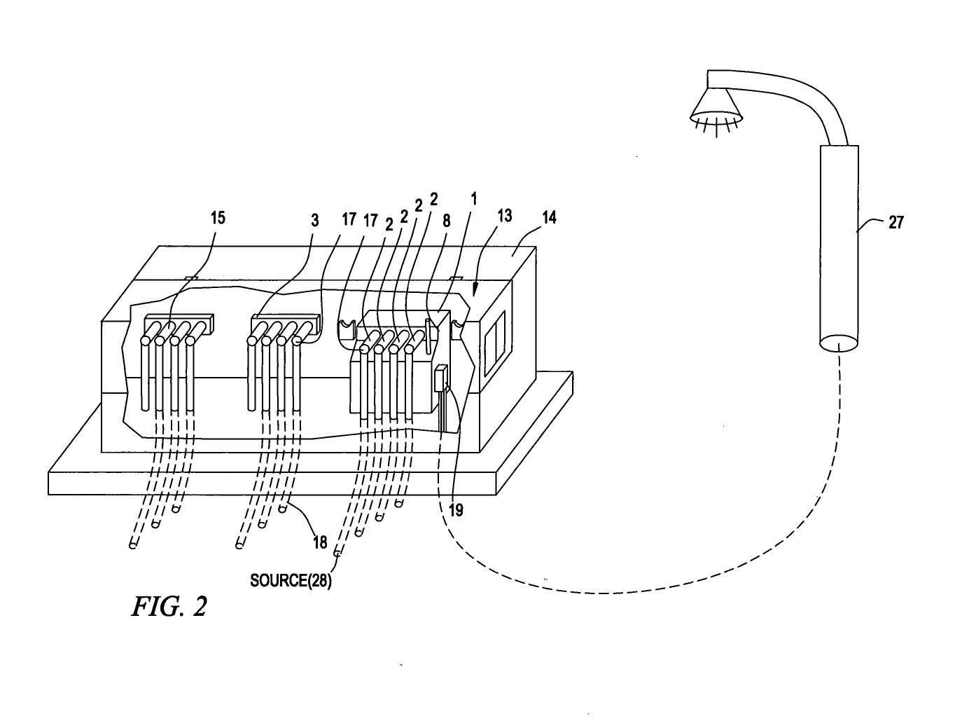

FIG. 2 shows a transformer junction module 1 installed in a sectionalizing cabinet 14 in accordance with one embodiment of the present invention. In particular,

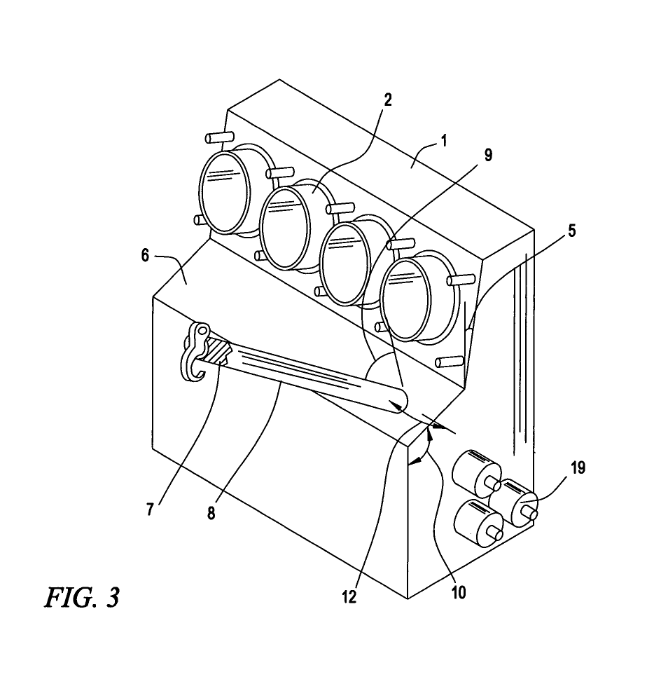

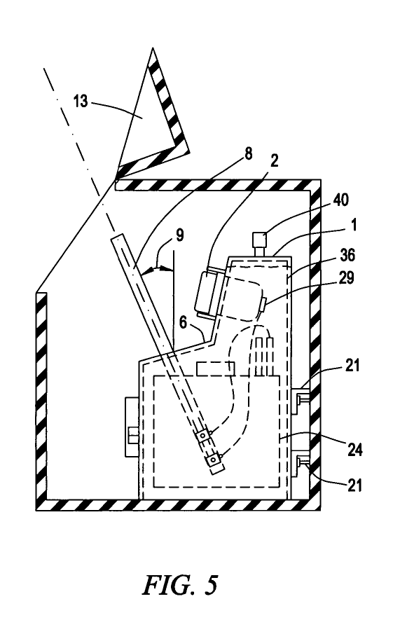

FIG. 2 is a cut-away illustration of the typical sectionalizing cabinet 14, showing a layout of the cabinet 14 with a transformer junction module 1 installed. Typically, a sectionalizing cabinet 14 may contain two junction modules 3 and a transformer junction module 1, but configurations may vary based on system requirements. The transformer junction module 1 includes recessed bushings 2 and a built-in transformer (not shown in detail). One of the bushings 2 connects to an external source 28, while the remaining bushings 2 can route power in multiple directions. Bushings 2 route sectionalized power through elbow connectors 17 or similar appropriate coupling devices. Elbows 17 and junction modules 3 may also be referred to as molded rubber products 15. Bushings 2 and core/coil assembly 24 (see FIG. 5) of the transformer are connected internally within the transformer junction module 1, i.e., preferably within a single housing. Bushings 2 are connected internally by a bus 29 (see FIG. 5), and core/coil assembly 24 is powered by an internal lead from bus 29 to a fuse located at the end of a fuse stabber 7. (See FIGS. 3 and 5.) Transformer junction module 1 advantageously does not require an additional external connection to a stand-alone transformer 4. (See FIG. 1.)

As shown in FIG. 2, the transformer junction module 1 design provides for an extra bushing 2, allowing the system to route power in three directions. The extra bushing 2 on the transformer junction module 1 can also be connected to a lightning arrester, which further enhances the system reliability. The transformer junction module 1 also provides secondary low voltage bushings 19, which may be used to supply power to applications 27 external to the system, such as streetlights, billboards, traffic controls, etc.

FIG. 3 shows an isometric view of a transformer junction module 1 with top front surface-mounted horizontal bushing wells prior to installation of bushing inserts. The recessed bushings 2 may be bussed together (see FIG. 5) in any manner desired to aid in sectionalizing based on the requirements of the specific system. Bushings 2 are preferably angled upward either by angling the bushings 2 and/or by angling the front wall upward at an angle 5, to aid in installation and removal of elbow connectors 17 during pad mount applications. (See FIG. 2). The deck 6 of the transformer junction module 1 is preferably angled downward at an angle 10 from the bushings 2 to increase strike distance during bushing 2 removal, to aid in runoff of any excess liquids that may gather on the deck, and to eliminate excess material costs and provide efficient use of space. Angle 10 is preferably within one hundred to one hundred thirty-five (100 to 135) degrees, i.e., a 10 to 45 degree slope. FIG. 3 also illustrates the secondary low voltage connection points, in this case, bushings 19, which supply power to applications 27 external to the junction system, such as streetlights, billboards, controls, etc.

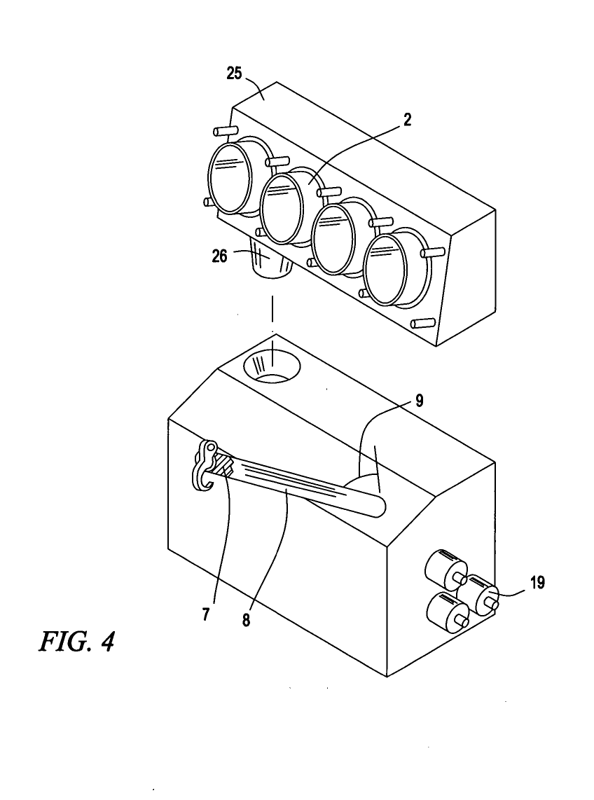

FIG. 4 shows an isometric view of a transformer junction module 1 with removable top-mounted horizontal bushings 25. The bushings 2 of the transformer junction module 1 can be designed as one piece with the transformer unit or as a removable top-mounted molded or other method of construction integral bushing unit 25. The removable top-mounted bushings 25 can be connected to the base unit, for example, with a quick-connect dead front interface 26, such as an integral tulip contact or similar appropriate method. The quick-connect dead front interface 26 may be mounted with the base as a single unit, still providing an internal connection of the transformer and the bushings 2 by an internal lead from bus 29 (see FIG. 5) to a fuse located at the end of a fuse stabber 7. This split design can increase the ease of system maintenance and assist in system reliability by enhancing access to the system's parts.

FIG. 5 shows in cross-section a core/coil assembly 24 of a transformer junction module 1 and a fuse holder tube 8 projecting from an angled deck 6 of the transformer junction module 1 in accordance with one preferred embodiment. Core/coil assembly 24 feeds off a main system by a transformer protection assembly, other embodiments may not require over-current protection. Bushings 2 and core/coil assembly 24 of the transformer are connected internally within the transformer junction module 1. A bus 29 connects primary bushings 2 internally, and core/coil assembly 24 is powered by an internal lead from the bus 29 to the fuse located at the end of a fuse stabber 7. (See FIG. 3.) A fuse positioned at the end of a fuse stabber 7 is one implementation of the transformer protection assembly. (See FIG. 3.) Fuse stabber 7 is inserted within a fuse holder tube 8 that is positioned within the surface of an angled deck 6. The length and orientation of the fuse holder tube 8 and fuse stabber 7 are selected based on system requirements and specifications, relating to the size and configuration of the cabinet 14. Surrounding the internal portion of the fuse tube is a gas deflector 36 which shields the ground plane from conductive ionized gasses that are generated under certain conditions. In addition to shielding the ground plane the deflector also directs gasses in the direction of the pressure relief valve 40.

Lateral angle 9 of the fuse holder tube 8 is preferably within zero to eighty (0 to 80) degrees of a longitudinal vertical plane, which is sufficient to permit removal of fuse stabber 7 when the transformer junction module 1 is installed within the sectionalizing cabinet 14, such that it clears overhang 13 of the cabinet 14. In other implementations unrestricted by cabinet overhang 13, such as buildings or vaults, the fuse angle can vary outside of this range. Longitudinal angle 12 (See FIG. 3) of the fuse tube holder 8 is preferably within forty-five to ninety (45 to 90) degrees of a longitudinal horizontal plane, which is additionally sufficient to facilitate removal in a direction that will minimize oil spill or avoid contamination of molded rubber products 15 (see FIG. 2) from any liquid dielectrics. Transformer junction module 1 can be mounted in a sectionalizing cabinet 14 (See FIG. 2) in nearly any convenient manner, for example, using slotted brackets 21 to secure the transformer junction module 1 to the back wall of the cabinet 14. An optional mounting stand 20 (not shown) can also be used to support the transformer junction module 1 within the sectionalizing cabinet 14.

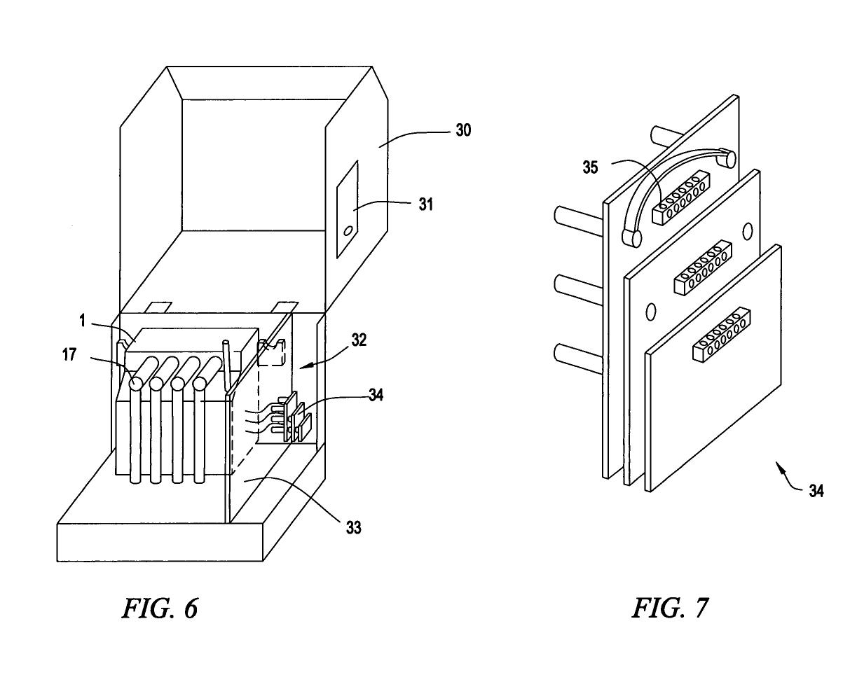

FIG. 6 shows a second preferred embodiment for providing a stand-alone transformer junction module 1 with the multiple bushings 17 in the recessed position in a single housing 30 specially designed to contain the unit. For simplicity, and in one preferred arrangement of the device, only four primary bushings are contained in the compact device, as shown. However, it is understood that fewer or more primary bushings may also be provided in such an arrangement, depending upon the intended application. The unit has a separate side access door 31 for accessing the secondary bushings or connections 34 in the secondary compartment 32. This unit provides the primary sectionalizing function and secondary power in one compact and low profile unit. This unit has all of the features referred to in connection with the first embodiment, but is embodied in a compact housing rather than being intended for installation in a sectionalizing vault or cabinet, possibly previously existing. Additionally the secondary compartment 32 is at least spatially separated and is furthermore preferably physically separated from the primary compartment by a non-conductive partition 33 for added safety. This partition of non-conductive material provides insulation and provides electrical clearance so that no high voltage components come in contact with the low voltage components. This barrier 33 also protects individuals from coming in contact with high voltage components when accessing the unit through the side access doors 31. As in the case of the embodiment of FIG. 2, the transformer-junction module combination can be mounted on the inside rear wall of housing 30, for example, by means of a bracket arrangement or other fastener. Alternatively, the combined unit can be welded or otherwise more permanently fastened to the inside wall of the housing 30.

FIG. 7 shows one preferred embodiment for providing secondary connections on a secondary connection assembly. The secondary wires are brought up from the ground and connected to the secondary blocks 35. This block assembly can be pulled away from the main transformer junction housing by a handle or other method and pivot on hinges at the bottom or side of the unit and may be disconnected from the electrical circuit by tulip contacts, blade contacts or other method, to provide a visible break to operators. This allows operators to open the circuit to insure they are working on de-energized equipment. Alternatively, the non-conductive partition can be made to move in a way that provides a visible break in the connection of the secondary connection assembly. Obviously, this feature can be used in conjunction with any transformer assembly, i.e., it does not require the integrated transformer-junction module employed according to the preferred embodiment of the present invention.

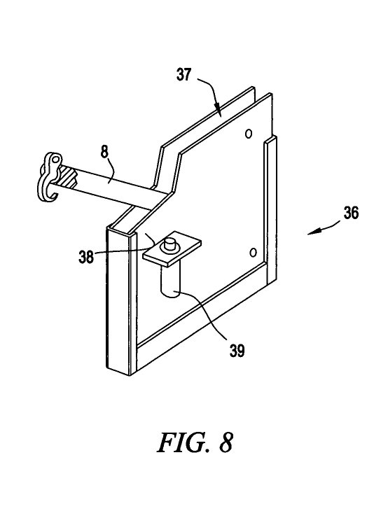

FIG. 8 shows in more detail the gas deflector 36, which is internal to the housing of the transformer junction box 1. The upper portion of the unit 37 is open to allow for directing of the rising gasses to the pressure relief area of the housing (not shown in detail) when gasses are generated in the case of an arcing event from a fuse, switch or other method. The sides, bottom, front and back of the unit are constructed of a non-conductive material. The top sections are preferably partially covered to insure that gases are directed to the area of the pressure relief valve. The external wall 38 of the housing can preferably be used to support a fuse 39 or other protective device that may require internal support.

Any use of the term “bushing” is intended to cover and incorporate all forms including, without limitation to, bushing wells, bushing wells with inserts, integral one-piece bushings, and bushings of any ampere rating, setting, or configuration. Other substitutions, modifications, changes and/or omissions may be made in the design, operating conditions and arrangement of the preferred and other exemplary embodiments without departing from the present invention as described herein. The term “compartment” in reference to secondary compartment is defined as an area that is physically or at least spatially separated from any high voltage components. The purpose of this compartment is to increase safety and provide at least a spatial separation and preferably a physical separation when operating the unit between the high voltage and low voltage components; it is a distinct separated area in which only low voltage components can readily be accessed.

The construction and arrangement of the elements of the transformer junction module as shown in the preferred and other exemplary embodiments are illustrative only. Although only a few embodiments of the present invention have been described in detail in this disclosure, those skilled in the art who review this disclosure will readily appreciate that many modifications are possible (e.g., variations in sizes, dimensions, structures, shapes and proportions of the various elements, values of parameters, mounting arrangements, materials, colors, orientations, etc.) without materially departing from the novel teachings and advantages of the subject matter recited herein. Accordingly, all such modifications are intended to be included within the scope of the present invention as described herein.

1. A compact integral transformer-junction module combination suitable for use in junction modules and vaults in electrical distribution circuits and in industrial and commercial circuits, comprising: a transformer, and a sectionalizing element comprising a plurality of primary bushings, wherein the sectionalizing element is combined with the transformer into a single unit, and the plurality of primary bushings are connected together, via an internal connection within the unit.

2. A transformer-junction module combination as claimed in claim 1, further comprising a housing within which the transformer-junction module combination is located.

3. A transformer-junction module combination as claimed in claim 2, wherein the plurality of primary bushings are connected together by a bus connection.

4. A transformer-junction module combination as claimed in claim 2, further comprising, within the housing, at least one connection point for supplying secondary power to application(s) external to the housing.

5. A transformer-junction module combination as claimed in claim 4, wherein the transformer has a power rating of less than 10 kVA.

6. A transformer-junction module combination as claimed in claim 2, wherein the primary bushings comprise bushings that are recessed from the front elevation of the unit and are vertical to upwardly angled to aid in the installation and removal of elbow connectors.

7. A transformer-junction module combination as claimed in claim 2, further comprising a device for protecting a core/coil assembly of the transformer from over-current.

8. A transformer-junction module combination as claimed in claim 7, wherein the protection device comprises a fuse and a fuse holder.

9. A transformer-junction module combination as claimed in claim 2, wherein the unit has a front cover leading up to the primary bushings, the front cover forming a deck that is angled down from the bushings to the front cover surface.

10. A transformer-junction module combination as claimed in claim 4, wherein the secondary bushings are separated from the primary voltages by non-conductive material covering.

11. A transformer-junction module combination as claimed in claim 2, further comprising a device for mounting the unit into said housing configured as a cabinet or vault.

12. A transformer-junction module combination as claimed in claim 11, wherein the mounting device comprises at least one reversible slotted mounting bracket.

13. A transformer-junction module combination as claimed in claim 2, wherein the sectionalizing element is mounted on top of the transformer.

14. A transformer-junction module combination as claimed in claim 13, further comprising a quick-connect, selectively removable connection between the transformer and the sectionalizing element.

15. A transformer-junction module combination as claimed in claim 13, further comprising a protective device for protecting the transformer core/coil assembly against over-current, wherein the protective device comprises a tube that enters into the transformer from the top at an angle to the vertical, and a protective member that is selectively insertable and removable from the tube, said angle being sufficient to enable removal of the protective member from the transformer located in the housing.

16. A transformer-junction module combination as claimed in claim 4, wherein the connection point for secondary power comprises a plurality of secondary bushings and/or blocks.

17. A transformer-junction module combination as claimed in claim 4, further comprising a portion of the internal space of the housing that defines a separate compartment in which the connection point for secondary power is located, said compartment having an access opening for accessing the connection point for secondary power that is separate from an opening in the housing for accessing the primary bushings.

18. A transformer-junction module combination as claimed in claim 17, further comprising at least one dielectric member separating the compartment from the remainder of the internal space within the housing, wherein the at least one connection point for supplying secondary power is mounted on one of said dielectric members, and wherein the combination further comprises a movable connection mechanism for said dielectric member or said connecting point, for enabling a visible break between the secondary connection(s) and the transformer.

19. A transformer-junction module combination as claimed in claim 2, further comprising, internal to the combined unit, a gas deflecting assembly for diverting conductive gas generated within the housing away from the ground plane.

20. A transformer-junction module combination as claimed in claim 19, further comprising at least one device for protecting against over-voltage and/or over-current, mounted on the external wall of the gas deflecting assembly, opposite to the side on which gas may be generated.

21. A method for combining a sectionalizing function and a transformer function for an electrical distribution system, comprising: providing a transformer, providing multiple primary bushings having a sectionalizing function, and joining the bushings and the transformer into a single unit having an internal connection within the unit.

22. A method as claimed in claim 21, further comprising: installing the unit comprising the bushings and transformer in a single housing.

23. A method as claimed in claim 21, wherein the internal connection comprises a bus connection.

24. A method as claimed in claim 22, further comprising: providing at least one secondary power connection point for an external application, within said housing.

25. A method as claimed in claim 23, further comprising sizing the transformer unit to less than 10 kVA.

26. A method for providing secondary, low voltage power at an electrical distribution junction in an electrical distribution system, in a single unit, comprising: supplying high voltage power to an integral transformer-junction module combination as claimed in claim 1 which is installed in a sectionalizing containment housing; stepping down the high voltage power to a low voltage power in the transformer; and supplying to at least one application, located external to the containment housing, the low voltage power from at least one secondary power connection point within the containment housing.

27 A method as claimed in claim 26, wherein the integral transformer-junction module combination further defines within the containment housing a secondary low voltage compartment protected and defined by electrical insulating materials, to insure no high voltage components come in contact with low voltage equipment.

28. A transformer unit, comprising: a transformer core with windings; at least one primary high voltage connection point on the transformer; and at least one secondary lower voltage connection point on the transformer, wherein the secondary lower voltage connection point comprises at least one secondary block mounted on a support mechanism, and the support mechanism is selectively movable to open the electrical connection between the secondary connection point and the transformer and to provide a visible indication of the opened electrical connection.
